(19) United States
(12) Patent Application Publication
(10) Pub. No.: US 2025/0231325 A1
(43) Pub. Date: Jul. 17, 2025

(54) LIGHT SHIELDING UNIT AND LENS BARREL INCLUDING SAME

(71) Applicant: Panasonic Intellectual Property Management Co., Ltd., Osaka (JP)

(72) Inventor: Shuhei AYUKAWA, Osaka (JP)

(73) Assignee: Panasonic Intellectual Property Management Co., Ltd., Osaka (JP)

(21) Appl. No.: 19/001,467

(22) Filed: Dec. 25, 2024

(30) Foreign Application Priority Data
Jan. 11, 2024 (JP) 2024-002809

(51) Int. Cl. G02B 5/00; G02B 7/02

(52) U.S. Cl. CPC G02B 5/005; G02B 7/021

(57) ABSTRACT

A light shielding unit includes: a plurality of diaphragm blades; a drive ring that rotates to drive the plurality of diaphragm blades; a sensor that detects a rotation angle of the drive ring; a flexible printed board provided with the sensor; a base member that rotatably supports the drive ring, and includes a mounting surface on which the flexible printed board is mounted and a female screw hole; a fixing screw that engages with the female screw hole and fixes a first portion of the flexible printed board provided with the sensor to the mounting surface of the base member; and a sheet member interposed between a head portion of the fixing screw and the first portion of the flexible printed board. The base member includes a locking portion that restricts rotation of the sheet member.

### BACKGRUOUND

### Technical Field

The present disclosure relates to a light shielding unit for adjusting a light amount passing through a lens barrel, and a lens barrel provided with the light shielding unit.

### Description of the Related Art

JP 2005-156896 A discloses a camera diaphragm device (light shielding unit) including a Hall element (sensor) for detecting a rotation angle of a drive ring that drives a plurality of diaphragm blades. The Hall element detects a magnet adhered to the drive ring. The Hall element is provided on the flexible printed board. By fixing the flexible printed board to a base member that rotatably supports the drive ring via a fixing screw, the Hall element is appropriately disposed with respect to a magnet of the drive ring.

### SUMMARY

However, in the case of the light shielding unit described in JP 2005-156896 A, due to the rotation of the head portion of the fixing screw at the time of attaching the flexible printed board, a shear force parallel to the surface acts on the surface of the flexible printed board in contact with the head portion of the fixing screw. Due to the shear force, the flexible printed board rotates, and as a result, the signal path of the Hall element (sensor) may be damaged.

For example, when the Hall element is strongly brought into contact with the base member by the rotation of the flexible printed board and the contact state is maintained, the flexible printed board is maintained in a state where the internal stress is generated. The stress may damage the flexible printed board. In addition, the solder electrically connecting the Hall element and the flexible printed board is also maintained in a state in which the internal stress is generated. The stress may damage the solder. That is, the signal path of the sensor may be damaged.

Therefore, an object of the present disclosure is to suppress damage to a signal path of a sensor in a light shielding unit of a lens barrel in which a flexible printed board including the sensor is fixed by a fixing screw.

In order to solve the above problem, according to an aspect of the present disclosure, a light shielding unit is provided that includes:
a plurality of diaphragm blades;
a drive ring that rotates to drive the plurality of diaphragm blades;
a sensor that detects a rotation angle of the drive ring;
a flexible printed board provided with the sensor;
a base member that rotatably supports the drive ring, and includes a mounting surface on which the flexible printed board is mounted and a female screw hole;
a fixing screw that engages with the female screw hole and fixes a first portion of the flexible printed board provided with the sensor to the mounting surface of the base member; and
a sheet member interposed between a head portion of the fixing screw and the first portion of the flexible printed board,
wherein the base member includes a locking portion that restricts rotation of the sheet member.

Also, according to another aspect of the disclosure, a lens barrel is provided that includes:
at least one lens; and
the above light shielding unit.

According to the present disclosure, damage to a signal path of a sensor can be suppressed in a light shielding unit of a lens barrel in which a flexible printed board including the sensor is fixed by a fixing screw.

### BRIEF DESCRIPTION OF DRAWINGS

FIG. 1 is a front perspective view of a lens barrel according to an embodiment of the present disclosure;

FIG. 2 is a rear perspective view of the lens barrel;

FIG. 3 is a schematic cross-sectional view of the lens barrel;

FIG. 4 is a front perspective view of the light shielding unit in a state where diaphragm blades are opened;

FIG. 5 is a rear perspective view of the light shielding unit in a state where the diaphragm blades are opened;

FIG. 6 is a front perspective view of the light shielding unit in a state where the diaphragm blades are closed;

FIG. 7 is a front exploded perspective view of the light shielding unit;
FIG. 8 is a rear exploded perspective view of the light shielding unit;
FIG. 9 is a perspective view of a base member to which a motor and a flexible printed board are attached;

FIG. 10 is a front view of a part of the base member to which the motor and the flexible printed board are attached;

FIG. 11 is a perspective view of the base member in a state where the motor and the flexible printed board have been removed;

FIG. 12 is a front view of a part of the base member; and

FIG. 13 is a developed view of the flexible printed board.

### DETAILED DESCRIPTION

Hereinafter, an embodiment will be described in detail with reference to the drawings as appropriate. However, unnecessarily detailed description may be omitted. For example, a detailed description of a well-known matter and a repeated description of substantially the same configuration may be omitted. This is to avoid unnecessary redundancy of the following description and to facilitate understanding of those skilled in the art.

Note that the inventor(s) provides the accompanying drawings and the following description in order for those skilled in the art to fully understand the present disclosure, and does not intend to limit the subject matter described in the claims by the accompanying drawings and the following description.

Hereinafter, a lens barrel according to an embodiment of the present disclosure will be described with reference to the drawings.

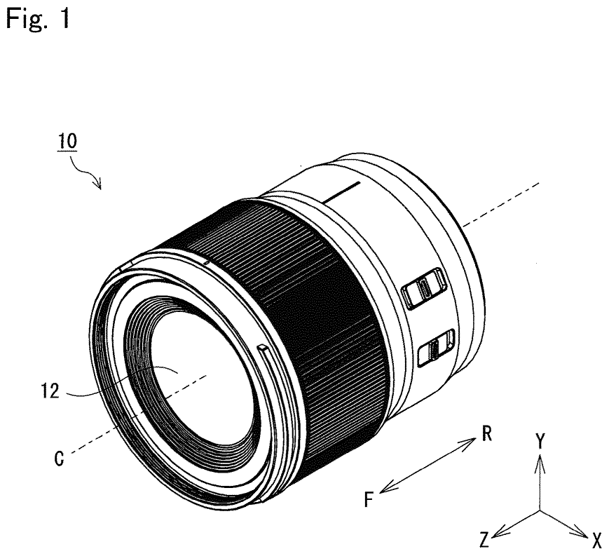

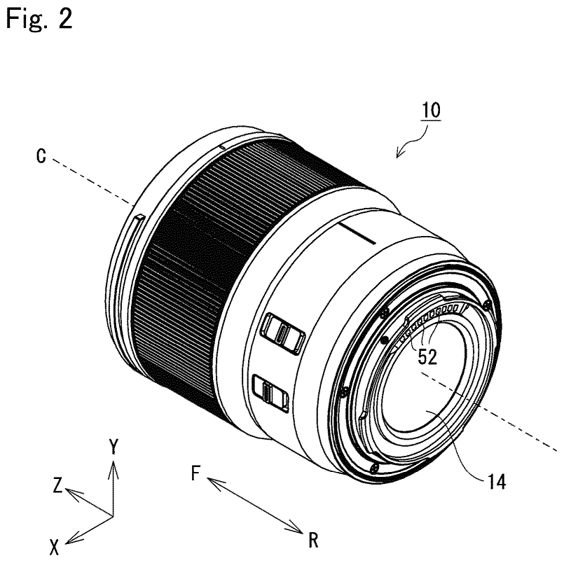

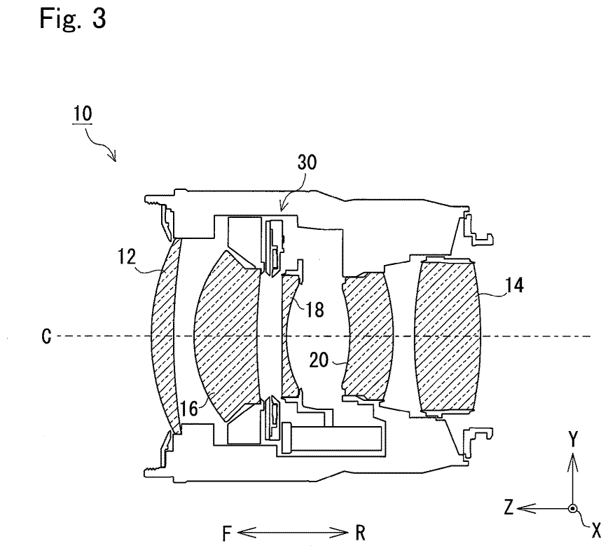

FIG. 1 is a front perspective view of a lens barrel according to an embodiment of the present disclosure. FIG. 2 is a rear perspective view of the lens barrel. FIG. 3 is a schematic cross-sectional view of the lens barrel.

Here, the X-Y-Z orthogonal coordinate system illustrated in the drawings is for facilitating understanding of the embodiment of the present disclosure, and does not limit the embodiment of the present disclosure. The Z-axis direction is an extending direction of the optical axis of the lens barrel, and the X-axis direction and the Y-axis direction are directions orthogonal to the extending direction of the optical axis. Note that, in the present specification, “front side (F)” is a subject side, and “rear side (R)” is an imaging device side.

As illustrated in FIGS. 1 to 3, lens barrel 10 according to the present embodiment includes a plurality of lenses 12-20. The lens 12 is the lens closest to the subject side, and the lens 14 is the lens closest to the imaging apparatus side. Furthermore, the lens barrel 10 includes the light shielding unit 30 that is disposed between the lenses 16, 18 and adjusts the light amount passing through the lens barrel 10.

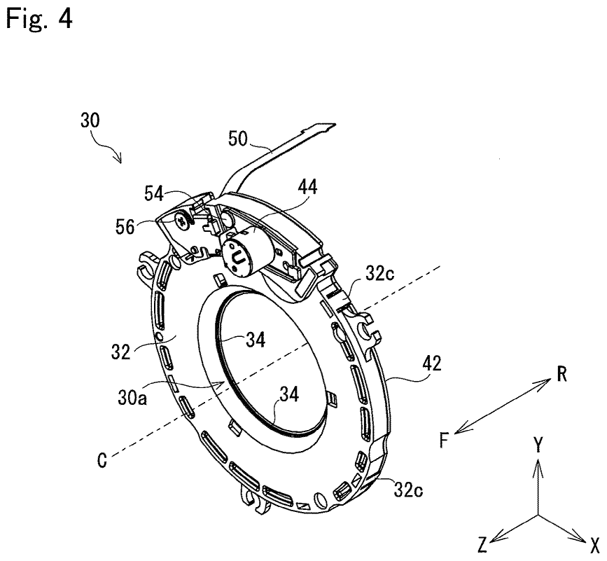

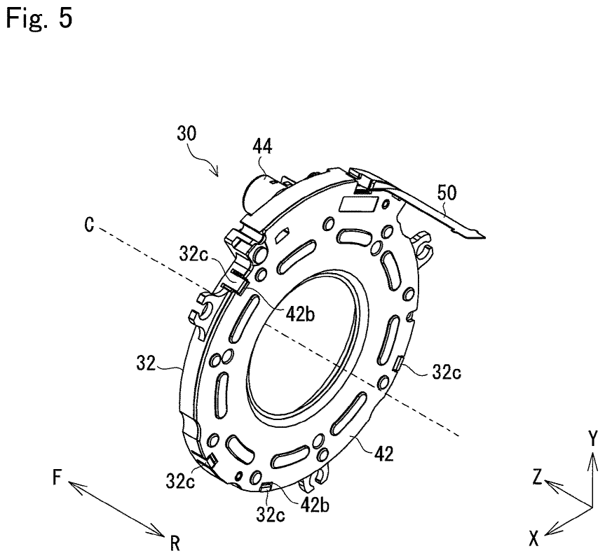

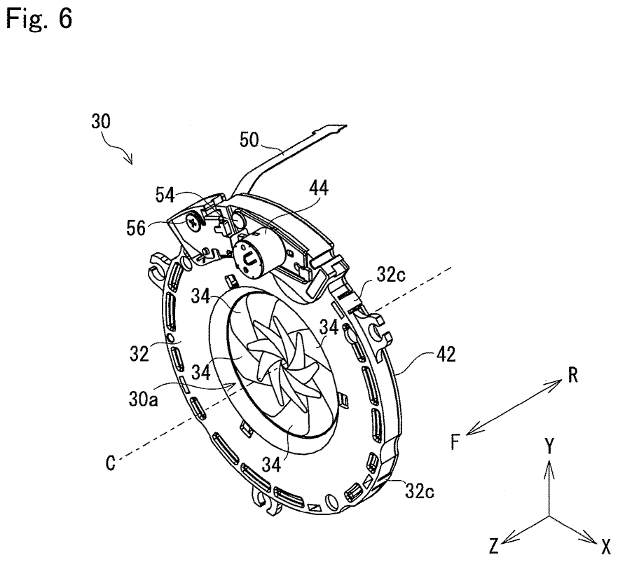

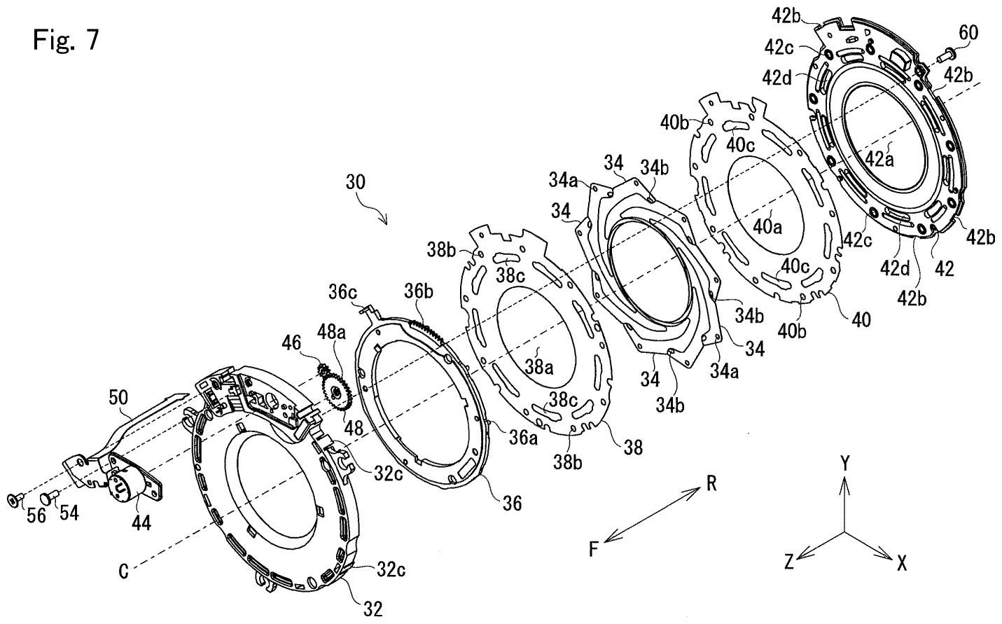

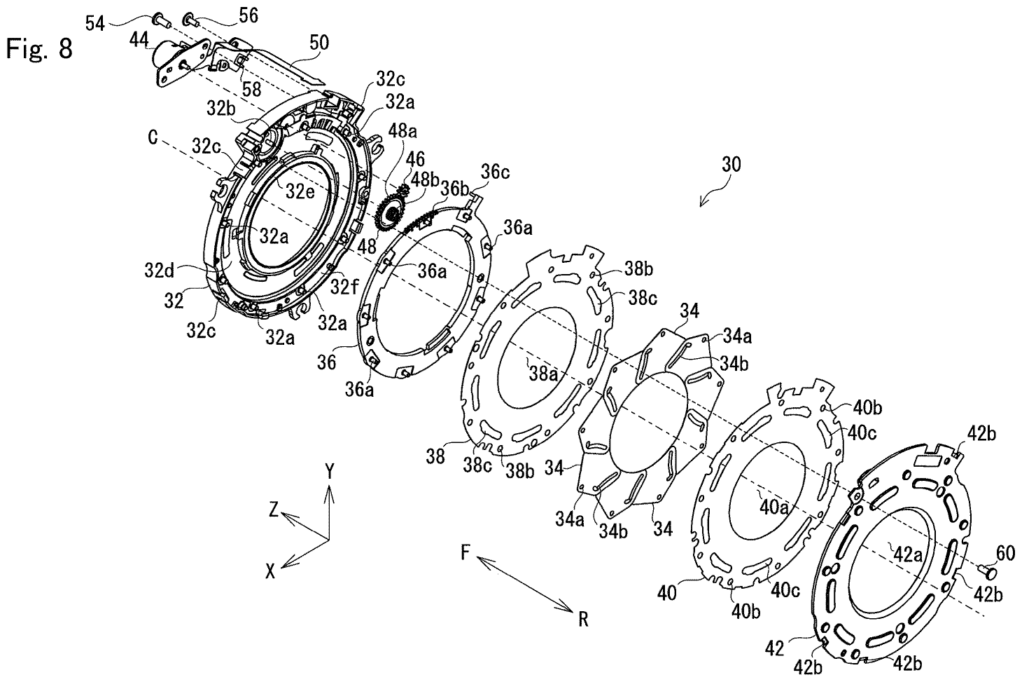

FIG. 4 is a front perspective view of the light shielding unit in a state where the diaphragm blades 34 are opened. FIG. 5 is a rear perspective view of the light shielding unit in a state where the diaphragm blades 34 are opened. FIG. 6 is a front perspective view of the light shielding unit in a state where the diaphragm blades 34 are closed. FIG. 7 is a front exploded perspective view of the light shielding unit. FIG. 8 is a rear exploded perspective view of the light shielding unit.

As illustrated in FIGS. 7 and 8, the light shielding unit 30 includes a base member 32, a plurality of diaphragm blades 34, a drive ring 36 that drives the plurality of diaphragm blades 34, a first sheet 38 disposed on the front side with respect to the plurality of diaphragm blades 34, a second sheet 40 disposed on the rear side with respect to the plurality of diaphragm blades 34, and a cover member 42.

The base member 32 generally has a shape in which a cylindrical wall extends from an annular end surface toward the rear portion of the lens barrel 10. The base member 32 accommodates the plurality of diaphragm blades 34, the drive ring 36, the first sheet 38, and the second sheet 40.

The plurality of diaphragm blades 34 are members for adjusting the light amount passing through the lens barrel 10. In the present embodiment, the light shielding unit 30 includes nine diaphragm blades 34 having the same shape. Each of the plurality of diaphragm blades 34 is supported by base member 32 so as to be rotatable about a rotation center line extending in the extending direction (Z-axis direction) of optical axis C of the lens barrel 10. For this purpose, each of the plurality of diaphragm blades 34 includes through holes 34a, and the base member 32 includes a plurality of support pins 32a passing through the respective through holes 34a. When the plurality of diaphragm blades 34 rotate, the light shielding unit 30 enters the open state illustrated in FIG. 4 or the closed state illustrated in FIG. 6. That is, when the plurality of diaphragm blades 34 rotate, the opening area of the opening 30a of the light shielding unit 30 through which light passes changes, and as a result, the light amount passing through the light shielding unit 30 changes.

The drive ring 36 is a ring-shaped member and is disposed between the base member 32 and the plurality of diaphragm blades 34. The drive ring 36 is supported by the base member 32 so as to be rotatable about the optical axis C. When the drive ring 36 rotates, each of the plurality of diaphragm blades 34 is driven from the opened state illustrated in FIG. 4 to the closed state illustrated in FIG. 6 or vice versa. For this purpose, each of the plurality of diaphragm blades 34 includes a cam groove 34b, and the drive ring 36 includes a plurality of pin-shaped cam followers 36a driven in each cam groove 34b.

In the present embodiment, the drive ring 36 is rotationally driven by the motor 44. For this purpose, the light shielding unit 30 includes a driving gear 46 attached to the motor 44 and a power transmission gear 48 meshing with the driving gear 46. The power transmission gear 48 includes a large-diameter gear portion 48a that meshes with the driving gear 46 and a small-diameter gear portion 48b that meshes with gear teeth 36b formed on the drive ring 36. The power transmission gear 48 is supported by a support pin 32b provided on the base member 32.

The motor 44 is electrically connected to the contact terminal 52 illustrated in FIG. 2 via the flexible printed board 50. As a result, the motor 44 is electrically connected to the imaging device via the contact terminal 52. The motor 44 is fixed to the base member 32 by a fixing screw 54, and the flexible printed board 50 is fixed to the base member 32 via a fixing screw 56. As illustrated in FIG. 8, a position sensor 58 for detecting the rotation angle of the drive ring 36 (specifically, the position of the tongue piece portion 36c provided in the drive ring 36) is mounted on the flexible printed board 50.

The first and second sheets 38 and 40 are annular sheet members in which the openings 38a and 40a are formed, and are made of a material having a light shielding property and smoothness, for example, a PET sheet. The first sheet 38 is disposed between the base member 32 and the plurality of diaphragm blades 34. The second sheet 40 is disposed between the plurality of diaphragm blades 34 and the cover member 42. That is, the first and second sheets 38 and 40 are provided in the light shielding unit 30 with the plurality of diaphragm blades 34 sandwiched in the extending direction (Z-axis direction) of the optical axis C. In this embodiment, a diameter of opening 40a of second sheet 40 is an aperture of lens barrel 10.

The plurality of diaphragm blades 34 are rotated by the drive ring 36 while sliding on the surfaces of the first and second sheets 38 and 40. The smoothness of the first and second sheets 38 and 40 allows the drive ring 36 to rotate with low torque. The first and second sheets 38 and 40 include engagement holes 38b and 40b that engage with the support pins 32a of the base member 32, and elongated holes 38c and 40c through which the cam followers 36a of the drive ring 36 pass.

The cover member 42 is a disk-shaped member having an opening 42a, and is attached to the base member 32. In the case of the present embodiment, the cover member 42 is engaged with the base member 32 by snap-fitting. For this purpose, the base member 32 is provided with a plurality of hooks 32c, and the cover member 42 is formed with recesses 42b that engage with the hooks 32c. After snap-fitting, the cover member 42 is fixed to the base member 32 via a fixing screw 60. The cover member 42 is formed with a plurality of support holes 42c for supporting the tips of the plurality of support pins 32a of the base member 32 and a plurality of guide grooves 42d for guiding the plurality of cam followers 36a of the drive ring 36. When such a cover member 42 is attached to the base member 32, the plurality of diaphragm blades 34, the drive ring 36, the first sheet 38, and the second sheet 40 are accommodated in the space defined by the cover member 42 and the base member 32.

As a supplement, as illustrated in FIG. 8, the drive ring 36 is accommodated in the annular recess 32d of the base member 32. The plurality of diaphragm blades 34, the first sheet 38, and the second sheet 40 are not accommodated in the recess 32d, and are disposed between the inner and outer annular surfaces 32e and 32f located inside and outside the annular recess 32d and the cover member 42. Therefore, the plurality of support pins 32a that support the plurality of diaphragm blades 34, the first sheet 38, and the second sheet 40 are provided on the outer annular surface 32f.

Hereinafter, further features of the light shielding unit 30 according to the present embodiment will be described.

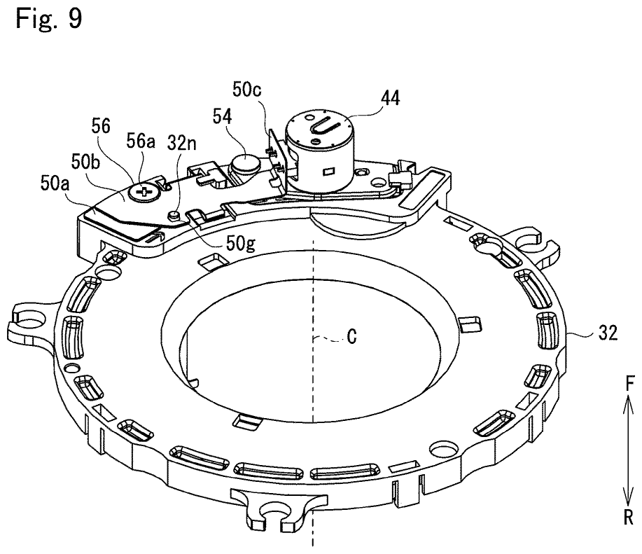

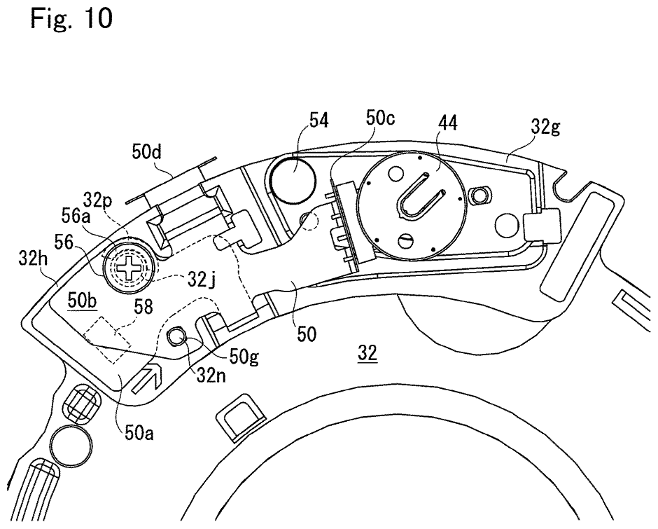

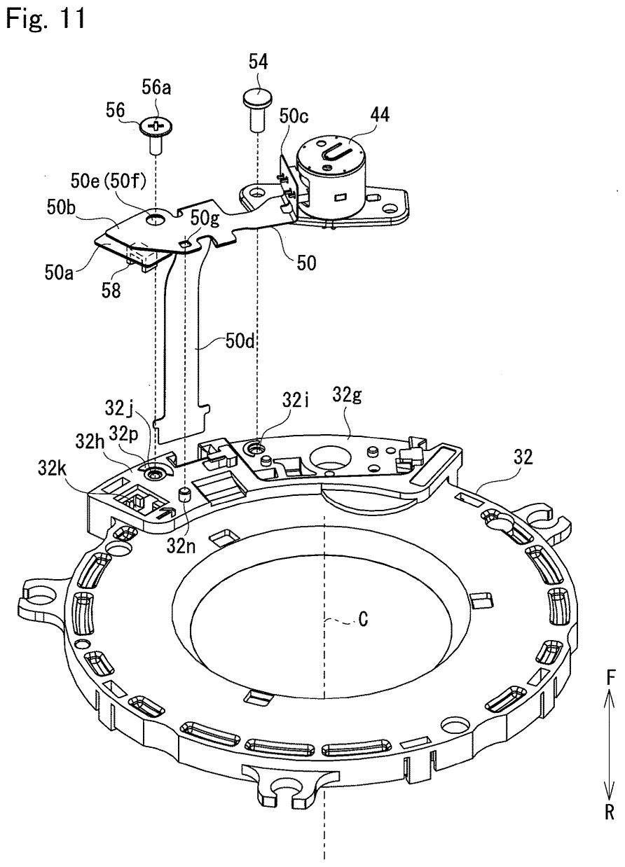

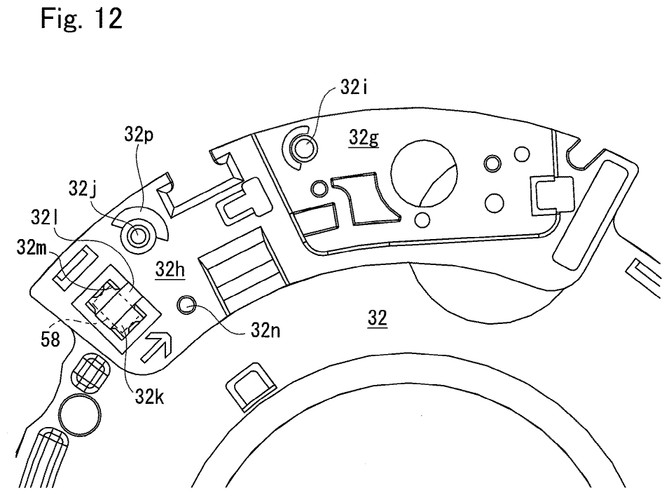

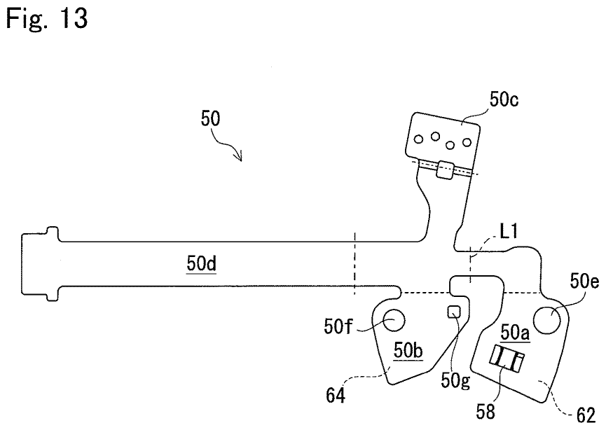

FIG. 9 is a perspective view of the base member to which the motor and the flexible printed board are attached. FIG. 10 is a front view of a part of the base member to which the motor and the flexible printed board are attached. FIG. 11 is a perspective view of the base member in a state where the motor and the flexible printed board are removed. Furthermore, FIG. 12 is a front view of a part of the base member. FIG. 13 is a developed view of the flexible printed board.

As illustrated in FIGS. 11 and 12, a mounting surface 32g on which the motor 44 is placed and fixed and a mounting surface 32h on which the flexible printed board 50 is placed and fixed are formed on the front surface of the base member 32. The motor 44 is fixed to the mounting surface 32g of the base member 32 via a fixing screw 54. Therefore, a female screw hole 32i to be engaged with the fixing screw 54 is formed in the mounting surface 32g.

The flexible printed board 50 is fixed to the mounting surface 32h of the base member 32 via the fixing screw 56. Therefore, the mounting surface 32h is formed with the female screw hole 32j that engages with the fixing screw 56.

Specifically, as illustrated in FIG. 13, the flexible printed board 50 includes a first portion 50a provided with the position sensor 58. In the case of the present embodiment, the flexible printed board 50 includes a second portion 50b different from the first portion 50a. Furthermore, in the case of the present embodiment, the flexible printed board 50 includes a third portion 50c electrically connected to the motor 44 and a fourth portion 50d electrically connected to the contact terminal 52.

As illustrated in FIGS. 9 to 11, the first portion 50a of the flexible printed board 50 is placed on the mounting surface 32h of the base member 32 with the position sensor 58 facing the mounting surface 32h. Therefore, as illustrated in FIGS. 11 to 12, a recess 32k in which the position sensor 58 is accommodated is formed on the mounting surface 32h.

As illustrated in FIG. 12, a through hole 321 through which the tongue piece portion 36c of the drive ring 36 detected by the position sensor 58 passes is formed at the bottom of the recess 32k. In addition, a positioning surface 32m that positions the position sensor 58 in one direction (a direction orthogonal to both the radial direction of the lens barrel 10 and the optical axis C) by coming into contact with the position sensor 58 is provided in the recess 32k.

In the case of the present embodiment, the flexible printed board 50 is bent such that the second portion 50b overlaps the first portion 50a of the flexible printed board 50 placed on the mounting surface 32h of the base member 32. By bending the flexible printed board 50 along the valley fold line L1 illustrated in FIG. 13, the second portion 50b overlaps the first portion 50a. Note that, in FIG. 13, a one-dot chain line indicates a valley fold line, and a two-dot chain line indicates a mountain fold line.

As shown in FIG. 13, in the case of the present embodiment, first and second through holes 50e and 50f through which the fixing screw 56 passes are formed in the first portion 50a and the second portion 50b of the flexible printed board 50, respectively. When the second portion 50b overlaps the first portion 50a, the first and second first and second through holes 50e and 50f also overlap as illustrated in FIG. 11. When the position sensor 58 provided in the first portion 50a is positioned by the positioning surface 32m of the base member 32, each of the through holes 50e and 50f overlaps the female screw hole 32j of the base member 32. The fixing screw 56 passes through each of the first and second through holes 50e and 50f and engages with the female screw hole 32j. As a result, the first portion 50a and the second portion 50b of the flexible printed board 50 are positioned while being fixed to the mounting surface 32h of the base member 32 in a state of overlapping each other. Although the reason will be described later, the first through hole 50e is larger than the second through hole 50f.

As illustrated in FIGS. 9 to 12, the base member 32 is provided with a locking portion 32n that restricts the rotation of the second portion 50b of the flexible printed board 50. In the case of the present embodiment, the locking portion 32n is a locking pin protruding from the mounting surface 32h. A locking hole 50g to be engaged with the locking portion 32n is provided in the second portion 50b of the flexible printed board 50.

The reason why the rotation of the second portion 50b is restricted by the locking portion 32n while the first portion 50a and the second portion 50b of the flexible printed board 50 are fixed to the base member 32 via the fixing screw 56 in the state of overlapping with each other as described above will be described.

As illustrated in FIG. 11, in order to engage the fixing screw 56 with the female screw hole 32j, the head portion 56a of the fixing screw 56 is rotated by a screwdriver. When the head portion 56a of the rotating fixing screw 56 comes into contact with the second portion 50b of the flexible printed board 50, a shear force parallel to the surface is generated on the surface of the second portion 50b in contact with the head portion 56a. Due to the shear force, the second portion 50b tends to rotate about the rotation center line extending in the axial direction of the fixing screw 56. However, the rotation of the second portion 50b is limited by the locking portion 32n provided on the base member 32.

On the other hand, since the first portion 50a of the flexible printed board 50 is not in direct contact with the head portion 56a of the rotating fixing screw 56 and the rotation of the second portion 50b is restricted, a shear force parallel to the surface (the surface facing the second portion 50b) is not generated. Therefore, the rotation of the first portion 50a is limited. As a result, rotation of the first portion 50a such that the position sensor 58 provided in the first portion 50a continues to strongly contact the base member 32 does not substantially occur. As a result, damage to the solder electrically connecting the position sensor 58 and the flexible printed board 50 is suppressed, and damage to the signal path of the position sensor 58 on the flexible printed board 50 is suppressed.

Unlike the present embodiment, it is conceivable that the first portion 50a is directly fixed to the base member 32 by the fixing screw 56 without providing the second portion 50b, and the first portion 50a is prevented from rotating by the locking portion 32n. However, when the locking hole 50g and the position sensor 58 are formed in the first portion 50a, there is a possibility that either or both the position of the locking hole and the mounting position of the position sensor are greatly shifted out of place. Consequently, in this case, the position sensor 58 may deviate from the design position or may not enter the recess 32k.

As a matter of course, in the case of the present embodiment, an internal stress is generated in a region between the second through hole 50f and the locking hole 50g of the second portion 50b. However, the conductive wire pattern such as the signal path of the position sensor 58 (and the signal path of the motor 44) is not provided in the second portion 50b. Therefore, even if the internal stress is generated in the second portion 50b by the rotation of the head portion 56a of the fixing screw 56, the signal path of the position sensor 58 is not affected.

In the case of the present embodiment, as described above, the diameter of the first through hole 50e of the first portion 50a through which the fixing screw 56 passes is larger than the diameter of the second through hole 50f of the second portion 50b. That is, the area of the region of the first portion 50a facing the head portion 56a of the fixing screw 56 is smaller than the area of the region of the second portion 56b facing the head portion 56a of the fixing screw 56. Accordingly, rotation of the first portion 50a due to rotation of the head portion 56a of the fixing screw 56 is suppressed.

In the case of the present embodiment, as illustrated in FIG. 10, a part of the second portion 50b of the flexible printed board 50 overlaps at least a part of the position sensor 58 as viewed in a direction orthogonal to the mounting surface 32h of the base member 32 (that is, as viewed in the extending direction of the optical axis C). Accordingly, separation of the position sensor 58 from the inside of the recess 32k of the base member 32 is suppressed. Specifically, since the second portion 50b overlaps the first portion 50a so as to overlap the position sensor 58, the occurrence of the deflection of the first portion 50a is suppressed, thereby suppressing the first portion 50a from being deflected and the position sensor 58 from being detached from the recess 32k. That is, the position sensor 58 is maintained in the recess 32k by the first portion 50a and the second portion 50b.

Furthermore, in the case of the present embodiment, as illustrated in FIGS. 10 to 12, the base member 32 is provided with a protrusion 32p in the vicinity of the opening of the female screw hole 32j. In the present embodiment, the protrusion 32p has an arc shape along the opening of the female screw hole 32j. Further, as viewed in the direction orthogonal to the mounting surface 32h (that is, as viewed in the extending direction of the optical axis C), the protrusion 32p faces the position sensor 58 across the female screw hole 32j, and overlaps a part of the head portion 56a of the fixing screw 56. Due to such a protrusion 32p, the first portion 50a and the second portion 50b of the flexible printed board 50 are fixed to the mounting surface 32h not in a planar state but in a state along the convex toward the mounting surface 32h. As a result, the position sensor 58 is further maintained in the recess 32k of the mounting surface 32h by the restoring force (elastic force) of the first and second portions 50a and 50b.

In the case of the present embodiment, as illustrated in FIG. 13, reinforcing sheets 62 and 64 are attached to the first and second portions 50a and 50b, respectively, of the flexible printed board 50. As a result, the elastic force of the first and second portions 50a and 50b increases.

Unlike the present embodiment, when the flexible printed board 50 (in particular the first and second portions 50a and 50b) is made of a material having a high elastic force, the second portion 50b may not overlap the position sensor 58, and the protrusion 32p may not be provided in the base member 32.

According to the embodiment as described above, in the light shielding unit of the lens barrel to which the flexible printed board including the sensor is fixed by the fixing screw, it is possible to suppress the damage of the signal path of the sensor.

Although the embodiment of the present disclosure has been described above with reference to the above-described embodiment, the embodiment of the present disclosure is not limited thereto.

For example, in the case of the above-described embodiment, as illustrated in FIGS. 9 to 11, the locking hole 50g of the second portion 50b of the flexible printed board 50 is engaged with the pin-shaped locking portion 32n of the base member 32. This configuration prevents the second portion 50b from rotating in accordance with rotation of head portion 56a of fixing screw 56. However, the suppression of the rotation of the second portion 50b is not limited thereto. For example, a protrusion in contact with the outer peripheral edge of the second portion 50b may be provided on the base member 32 as a locking portion.

In addition, in the case of the above-described embodiment, as illustrated in FIG. 13, the first and second through holes 50e and 50f through which the fixing screw 56 passes are provided in the first and second portions 50a and 50b of the flexible printed board 50. Instead of the first and second through holes, a U-shaped cutout portion through which the fixing screw 56 passes may be provided in each of the first and second portions 50a and 50b.

Furthermore, in the case of the above-described embodiment, the second portion 50b of the flexible printed board 50 different from the first portion 50a is interposed between the first portion 50a of the flexible printed board 50 and the head portion 56a of the fixing screw 56. However, the present embodiment is not limited thereto. The member interposed between the first portion 50a of the flexible printed board 50 and the head portion 56a of the fixing screw 56 may not be a part of the flexible printed board, and may be another sheet-like member.

That is, in a broad sense, the light shielding unit according to the embodiment of the present disclosure includes: a plurality of diaphragm blades; a drive ring that rotates to drive the plurality of diaphragm blades; a sensor that detects a rotation angle of the drive ring; a flexible printed board provided with the sensor; a base member that rotatably supports the drive ring, and includes a mounting surface on which the flexible printed board is mounted and a female screw hole; a fixing screw that engages with the female screw hole and fixes a first portion of the flexible printed board provided with the sensor to the mounting surface of the base member; and a sheet member interposed between a head portion of the fixing screw and the first portion of the flexible printed board, in which the base member includes a locking portion that restricts rotation of the sheet member.

As described above, the above-described embodiment has been described as an example of the technique of the present disclosure. To that end, the drawings and detailed description are provided. Therefore, the components described in the drawings and the detailed description may include not only components essential for solving the problem but also components that are not essential for solving the problem in order to illustrate the above-described technology. Therefore, it should not be immediately recognized that these non-essential components are essential based on the fact that these non-essential components are described in the drawings and the detailed description.

In addition, since the above-described embodiment is intended to illustrate the technique in the present disclosure, various changes, replacements, additions, omissions, and the like can be made within the scope of the claims or equivalents thereof.

The present disclosure is applicable to a lens barrel including a light shielding unit.

What is claimed is:

1. A light shielding unit comprising:
a plurality of diaphragm blades;
a drive ring that rotates to drive the plurality of diaphragm blades;
a sensor that detects a rotation angle of the drive ring;
a flexible printed board provided with the sensor;
a base member that rotatably supports the drive ring, and includes a mounting surface on which the flexible printed board is mounted and a female screw hole;
a fixing screw that engages with the female screw hole and fixes a first portion of the flexible printed board provided with the sensor to the mounting surface of the base member; and
a sheet member interposed between a head portion of the fixing screw and the first portion of the flexible printed board,
wherein the base member includes a locking portion that restricts rotation of the sheet member.

2. The light shielding unit according to claim 1,
wherein the sheet member is a second portion different from the first portion of the flexible printed board, and
the flexible printed board is bent such that the second portion is overlaid on the first portion.

3. The light shielding unit according to claim 2, wherein the first portion and the second portion of the flexible printed board are respectively provided with a first through hole and a second through hole through which the fixing screw passes.

4. The light shielding unit according to claim 3, wherein the first through hole is larger than the second through hole.

5. The light shielding unit according to claim 2,
wherein the base member includes a locking pin as the locking portion, and
a locking hole through which the locking pin passes is provided in the second portion of the flexible printed board.

6. The light shielding unit according to claim 2,
wherein the base member includes a recess on the mounting surface in which the sensor is accommodated, and
a part of the second portion of the flexible printed board overlaps at least a part of the sensor as viewed in a direction orthogonal to the mounting surface.

7. The light shielding unit according to claim 6, wherein, in the base member, a protrusion is formed that overlaps a part of the head portion of the fixing screw while facing the sensor across the female screw hole as viewed in a direction orthogonal to the mounting surface. 8 The light shielding unit according to claim 1, further comprising a motor that is provided in the base member and rotates the drive ring,
wherein the flexible printed board is connected to the motor.

9. A lens barrel comprising:
at least one lens; and
the light shielding unit according to claim 1.
